(19) United States
(12) Patent Application Publication
(10) Pub. No.: US 2004/0205537 A1
(43) Pub. Date: Oct. 14, 2004

(54) System and method for managing intellectual property assets

(75) Inventors: John D. Graham, New York, NY (US); Andrei E. Osipov, New York, NY (US)

Correspondence Address: DOUGLAS GRAHAM, CIRCLE TRUST COMPANY, 1 STATION PLACE, STANFORD, CT, 06902, US

(73) Assignee: IDDEX Corporation.

(21) Appl. No.: 09/766,067

(22) Filed: Jan. 19, 2001

Related U.S. Application Data
(60) Provisional application No. 60/176,860, filed on Jan. 19, 2000.

(51) Int. Cl. G06F 15/00

(52) U.S. Cl. 715/511

(57) ABSTRACT

Systems and methods for managing intellectual property are provided. These systems and methods may accept new pieces of intellectual property from creators of the intellectual property and then record the intellectual property, control access to the intellectual property, facilitate use and integration of the intellectual property, and track information relating to the intellectual property. Using five basic data structures, one embodiment of the present invention enables the tracking of IP elements (e.g., a single idea or a new combination of ideas), IP assets (e.g., one or more IP elements with recognized value), metadata elements (e.g., supplemental information), log elements (e.g., change information), and user records (e.g., user information). In an implementation of the invention, a “lab notebook page” paradigm may be used to facilitate the entry of information into an IP element.

### CROSS REFERENCE TO RELATED APPLICATION

This application claims the benefit of U.S. Provisional Patent Application No. 60/176,860, filed Jan. 19, 2000, which is hereby incorporated by reference herein in its entirety.

### BACKGROUND OF THE INVENTION

This invention relates to systems and methods for managing intellectual property. More particularly, this invention relates to systems and methods for creating records of intellectual property, for tracking that intellectual property, and for facilitating use of that intellectual property.

Lab notebooks are widely used by inventors and scientists to record their inventions and discoveries. The use of lab notebooks has been recognized as a useful way of recording inventions and discoveries at least in part because the lab notebooks, when properly signed and witnessed, can establish a date of invention or a date of discovery for an inventor or scientist. Lab notebooks are also useful because they create a central location for all of the inventions and discoveries created by an inventor or scientist.

Nevertheless, lab notebooks also have drawbacks in that the content of the notebooks is difficult to distribute and coordinate among a large group of people, the lab notebooks may be easily misplaced or stolen, the lab notebooks may be fraudulently completed, the lab notebooks are not easily searchable or linkable, etc.

Electronic databases may be used to provide a substitute for the traditional lab notebook. Moreover, electronic databases provide processing capabilities that can be used to greatly expand the functionalities provided by lab notebooks in recording inventions, discoveries, and other intellectual property.

It is, therefore, an object of the invention to provide systems and methods for managing intellectual property.

### SUMMARY OF THE INVENTION

In accordance with this and other objects of the present invention, systems and methods for managing intellectual property are provided. These systems and methods may accept new pieces of intellectual property from creators of the intellectual property and then record the intellectual property, control access to the intellectual property, facilitate use and integration of the intellectual property, and track information relating to the intellectual property. Using five basic data structures, one embodiment of the present invention enables the tracking of IP elements, IP assets, metadata elements, log elements, and user records. An IP element may be a single idea or a new combination of ideas that is recognized by a creator. An IP asset may be recognition of value in one or more IP elements. A metadata element may be used to provide supplemental information to other types of data structures. A log element may be used to track changes to other types of data structures. A user record may be used to track information relating to a user of the invention. In an implementation of the invention, a “lab notebook page” paradigm may be used to facilitate the entry of information into an IP element.

### BRIEF DESCRIPTION OF THE DRAWINGS

The above and other objects and advantages of the invention will be apparent upon consideration of the following detailed description taken in conjunction with the accompanying drawings in which like reference characters refer to like parts throughout and in which:

FIG. 1 is a block diagram of a system that may be used to implement various embodiments of the present invention;

FIG. 2 is a block diagram of processes that may be used in accordance with various embodiments of the present invention; and

FIGS. 3-9 are illustrations of user interfaces that may be presented in accordance with various embodiments of the present invention.

### DETAILED DESCRIPTION OF THE PREFERRED EMBODIMENTS

The present invention provides systems and methods for managing intellectual property. More particularly, the present invention accepts new pieces of intellectual property from creators of the intellectual property and then records the intellectual property, controls access to the intellectual property, facilitates use and integration of the intellectual property, and tracks information relating to the intellectual property.

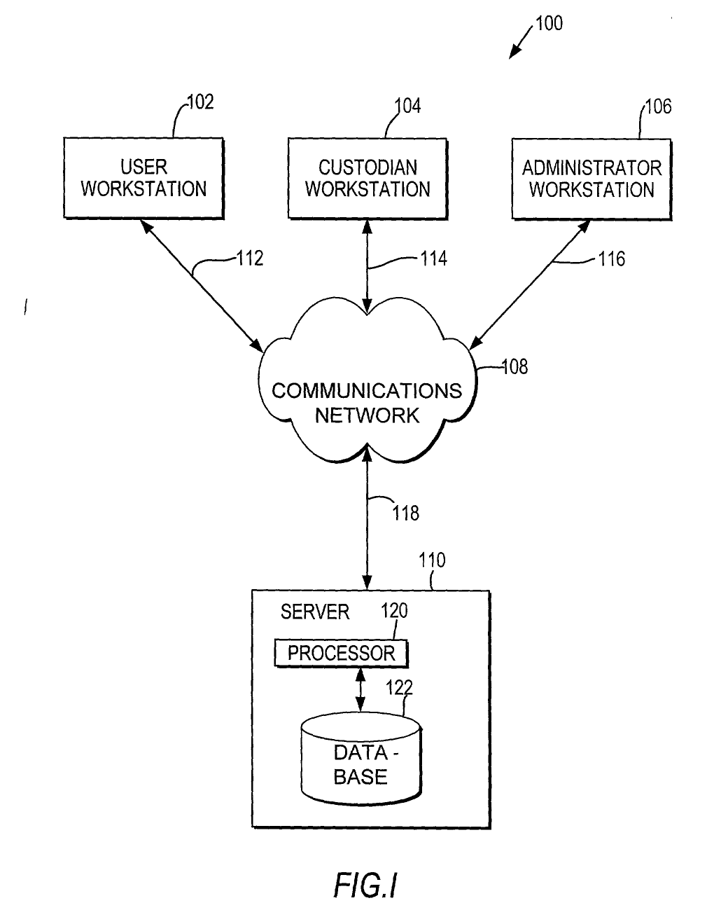

Turning to FIG. 1, a system 100 that may be used to implement various embodiments of the present invention is shown. As illustrated, system 100 may include a user workstation 102, a custodian workstation 104, an administrator workstation 106, a communications network 108, a server 110, and communication links 112, 114, 116, and 118.

Workstations 102, 104, and 106 may be any suitable device or devices for presenting information to and receiving information from users, custodians, and administrators. A user may be any creator or recipient of information. A custodian may be a party who is responsible for verifying the integrity of the information contained in the system. An administrator may be a party with the ability to oversee the work and access to the system of users of the system. Workstations 102, 104, and 106 may be personal computers, laptop computers, hand-held computers, Internet appliances, telephones, interactive televisions, wireless devices, scanner, digital camera, digital white board, or any other suitable devices, or combination of the same. Workstations 102, 104, and 106 may present information to users, custodians, and administrators using a graphical user interface, through an audio interface, or through any other suitable interface, or combinations of interfaces. Workstations 102, 104, and 106 may receive information from users, custodians, and administrators using a keyboard interface, a pointing-device based interface, a pen-based interface, a voice recognition interface, or any other suitable interface, or combination of interfaces.

Communications network 108 may be any suitable network for communicating data between workstations 102, 104, and 106 and server 110. Communications network 108 may be implemented using the Internet, an Intranet, a local area network, a wide area network, a cable network, a telephone network, a wireless network, or any other suitable network, or combination of networks. Communication network 108 may use any suitable communications protocol such as TCP/IP, HTTP, FTP, etc.

Communication links 112, 114, 116, and 118 may be any suitable links for communicating data between workstations 102, 104, and 106, server 110, and communications network 108. For example, communication links 112, 114, 116, and 118 may be hard-wired connections, dial-up connections, wireless connections, cable modem connections, DSL connections, or any other suitable connections, or combination of connections.

Server 110 may be any suitable server or combination of servers for processing and storing data. Server 110 may include one or more processors 120 and one or more databases 122. Processors 120 and databases 122 may be located in one or more legal jurisdictions. In one embodiment of the present invention, workstations 102, 104, and 106 may be implemented using a client/server architecture in which Web browsers operating on workstations 102, 104, and 106 act as clients and request information from one or more server processes operating on server 110. Alternatively, email clients, such as Microsoft Outlook, or any other suitable applications could be used to provide a conduit to the functions of server 110. Databases 122 may be implemented using any suitable software and/or hardware based approach. For example, databases 122 may be implemented using database software from Oracle Corporation and a suitable data storage device, such as a fixed disk drive.

With one embodiment of the present invention, five basic types of information may be created and maintained in databases 122 to facilitate performance of the functions of the invention. These types of information are IP elements, IP assets; meta data elements; log elements; user records, and access control lists. Each of these types of information may be stored in any suitable data structure, such as a record, an array, a linked list, etc.

IP elements may be used within the present invention to store and track one or more pieces of intellectual property. For example, a new idea that is created by an inventor may be considered to be a piece of intellectual property. This idea may be a simple improvement to an existing product, or may be a revolutionary, complex system. Irrespective of how a piece of intellectual property is expressed (e.g., as a data file, document, audio file, video file, image file, digital fingerprint, etc.), it may be stored and tracked in an IP element as content. Content in an IP element may also include one or more other IP elements. Thus, when an existing idea is stored in an existing IP element, that idea may be combined with a new idea by storing the new idea as a document and linking to the existing IP element within the content of a new IP element.

An IP element may also contain indicators to indicate a unique identifier (e.g., a serial number) of the IP element, a time stamp for the IP element, the creator of the content of the IP element, the context of the IP element, and links to metadata for the IP element. The unique identifier for the IP element may be a simple sequentially assigned serial number or may be any other desirable unique identifier. By using a sequentially assigned serial number, a rough indicator of the sequence of creation of IP elements can be determined from the order of the unique identifiers of those IP elements. The time stamp may be used to determine the time of creation of an IP element. The time stamp may indicate date and time, date only, or any other suitable time indicator, and may use any desired level of precision (e.g., accurate to the second, minute, hour, day, month, or year). The creator of the content of the IP element may be a name of the creator, a number to identify the creator, a link to the user record of the creator, or any other suitable indicator of the creator of the content. The context of the content of the IP element may be a name of project associated with the content, a classification of the nature of the content (e.g., chemistry, physics, mathematics, economics, etc.), or any other suitable classifier of the content. Finally, the links to metadata may be links to one or more metadata elements, which are described below. Alternatively, metadata may be stored directly in an IP element. Metadata for an IP element may include any suitable information relating to the element. For example, metadata may include indicators of the author, the owner, values, the meaning, and dates of use, sale, and public disclosure of the content of the IP element.

IP assets may be used to identify one or more IP elements as having a special status as an asset. An asset, within the context of the invention, may be consider to be of some value to the owner of the intellectual property. An IP asset may include one or more links to IP elements and links to metadata elements for the asset. Alternatively, the one or more IP elements and metadata elements, or copies thereof, may be stored in the IP asset instead of using links to those elements. Metadata for an IP asset may include any suitable information relating to the element. For example, metadata may include indicators of the author, the owner, values, the meaning, and dates of use, sale, and public disclosure of the content of the IP asset.

Metadata elements may be used to store metadata relating to an IP element or an IP asset and may include, as indicated above, indicators of the author, the owner, values, the meaning, and dates of use, sale, and public disclosure of the content of an IP element or IP asset. Metadata elements may also contain a link to one or more log elements, which are described below.

Log elements may be used to record changes to any other types of information. For example, when a change is made to metadata relating to an IP element or IP asset, a log element may be created that indicates the date, time, and change to the IP element or IP asset.

User records may be used to store information relating to users of the present invention. This information may include personal information relating to the user, such as the user's name, address, date of birth, gender, social security number, etc. This information may also include employment data relating to the user, such as the user's employment status (active, retired, fired, etc.), position, employee number, work group, division, etc. The user information may further include function roles of the user, such as indicators of the user's responsibilities (e.g., creator, administrator, manager), projects (e.g., XYZ project), etc. The user information may also include credit information that tracks the user's contributions to the intellectual property tracked by the present invention.

Finally, access control lists may be used to link users to IP elements and IP assets. In addition to including links to one or more users and one or more IP elements and/or IP assets, the access control lists may include indicators the indicate the time periods during which any links are to be active and under what conditions a link is to be active.

In each of the IP elements, IP assets, metadata elements, log elements, user records, and access control lists, the links that are mentioned above may be bidirectional so that two linked items can be identified when examining either item. For example, if a metadata element is linked to an IP asset, by examining the metadata element, the IP asset can be identified, and by examining the IP asset, the metadata element can be identified. Additionally, for each link in the IP elements, IP assets, metadata elements, log elements, user records, and access control lists, suitable backup information may also be maintained in the IP elements, IP assets, metadata elements, log elements, user records, and access control lists to reconstruct the target for the link should the link be determined to have failed. Thus, for example, if a metadata element has a link to an IP element, the unique identifier of the IP element may also be stored in the metadata element.

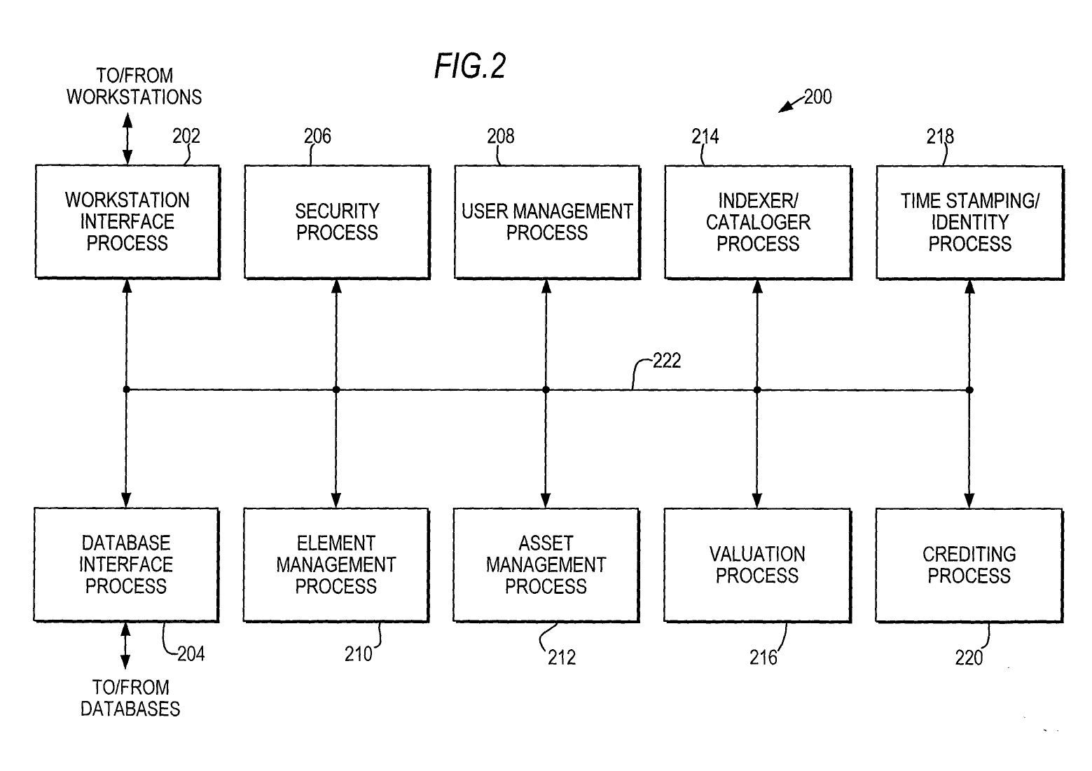

The functions that are performed on and using the IP elements, IP assets, metadata elements, log elements, user records, and access control lists are now described in connection with FIGS. 2-9. Turning to FIG. 2, a server process 200 that may be used to create, modify, and display data from the IP elements, IP assets, metadata elements, log elements, user records, and access control lists is illustrated. As shown, process 200 may include a workstation interface process 202, a database interface process 204, a security process 206, a user management process 208, an element management process 210, an asset management process 212, a indexer/cataloger process 214, a valuation process 216, a time stamping/identity process 218, and a crediting process 220. Processes 202, 204, 206, 208, 210, 212, 214, 216, 218, and 220 may communicate with each other using any suitable hardware and/or software interface 222.

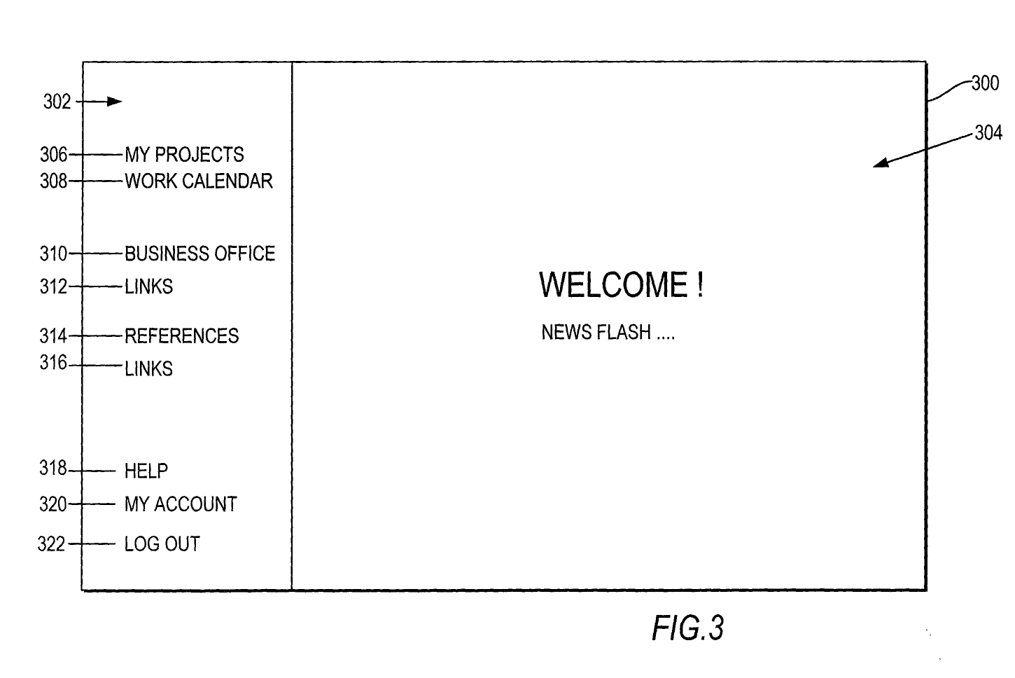

Turning first to workstation interface process 202, this process may be used to communicate with workstations 102, 104, and 106 and control processing of all data received from and going to the workstations. For example, when a request is received from a workstation 102, that request may be received by process 202 and redirected to another process 204, 206, 208, 210, 212, 214, 216, 218, or 220. Process 202 may then wait for a response back from the other process and communicate that response to workstation 102. When used in a client/server architecture in which workstations 102, 104, and 106 access server 110 using Web browser, process 202 may format data received from the other processes into suitable Web page interfaces, such as those illustrated in FIGS. 3-9 and discussed in connection therewith below. Examples of specific functions that may be performed by process 202 will be apparent from the descriptions of the other processes which follow.

Database interface process 204 may be used to control the flow of data to and from database 122. Process 204 may receive requests to retrieve data from or post data to each of processes 202, 206, 208, 210, 212, 214, 216, 218, and 220. Process 204 may also control access to database 122 based upon any suitable rights of priority assigned to the other processes. For example, if another process has a piece of data from database 122 open, process 204 may prevent a third process from accessing that piece of data. Process 204 may be particularly used to create, retrieve, and/or modify IP elements, IP assets, metadata elements, log elements, user records, and access control lists from other pieces of data.

Security process 206 may be used to control access to the IP elements, IP assets, metadata elements, log elements, user records, and access control lists. This may be accomplished by process 206 by maintaining security tokens, authenticating the validity of a token, granting authorization to access IP elements, IP assets, metadata elements, log elements, user records, and access control lists, encrypt IP elements, IP assets, metadata elements, log elements, user records, and access control lists, create digital signatures, and require assurances of security.

Maintaining security tokens may include creating, enabling, disabling, and updating security tokens. A security token may be a user identification and password, a fingerprint, a retina scan, a security card or badge, or any other suitable means for identifying a user. Authenticating the validity of a token may involve receiving a token from a user and verifying that the token is valid. Granting authorization may involve checking a user's identity against the access control list, and creating and updating access control lists, for an IP element, IP asset, metadata element, log element, or user record that the user desires to access. In creating and updating an access control list, security process 206 may assign access based upon any suitable information relating to a user (such as the user's function roles) or the item (such as an IP element or IP asset) corresponding to the access control list. Encryption may involve securing data against unauthorized access using any suitable encryption method, such as PGP. Encryption may also include transmitting one or more secure keys to a processor 120 located in another jurisdiction. Creating digital signatures may involve creating an indication that a user electronically signed a piece of information and creating an indicator of the authenticity of a piece of information. Finally, requiring assurances of security may involve require a user to electronically sign a non-disclosure agreement, provide proof of an escrow or bond of security, etc.

User management process 208 may be used to create, update, and access the information in the user records. As indicated above, this information may include personal information relating to the user, such as the user's name, address, date of birth, gender, social security number, etc., employment data relating to the user, such as the user's employment status (active, retired, fired, etc.), position, employee number, work group, division, etc., function roles of the user, such as indicators of the user's responsibilities (e.g., creator, administrator, manager), projects (e.g., XYZ project), etc., and credit information.

Element management process 210 may be used to create draft IP elements, update draft IP elements, aggregate IP elements, and register draft IP elements into final form. Creating a draft IP element may involve receiving information relating to the content of the IP element from the user, assigning a unique identifier to the IP element, obtaining a time stamp and creator information from time stamping/identity process 218, receiving metadata from the user, if any, creating a metadata element, creating a log element, instructing security process 206 to create an access control element, and linking the IF element, the metadata element, the log element, the user record of the user, and the user records of any other users indicated in the access control element to the access control element. Updating draft IF elements may involve making changes to the content and the metadata of a draft IF element. Aggregating IF elements may involve permitting a user to include another IF element as content in an IF element. Finally, registering a draft IF element into final form may involve designating the IP element as being final and obtaining a final time stamp from time stamping/identity process 218. When an IP element is registered, the IF element is preferably automatically directed to another user who acts as one or more witnesses for the IF element and digitally signs the IF element. Once an IF element is made final, the IF element preferably cannot be subsequently altered.

Asset management process 212 may be used to create draft IF assets, update draft IF assets, convert draft IF assets to final, convert final IF assets back to draft, and assign subsequent action flags to IP assets. Creating a draft IP asset may involve receiving an indication of which IP elements are to be linked to the IP asset, creating the links to those IP elements, receiving metadata for the asset from the user (such as creator of the IP asset, owner of the IP asset, values associated with the IP asset, purpose and meaning of the IP asset, dates of use, sale, and public disclosure of the IP asset), creating a metadata element, creating a log element, instructing security process 206 to create an access control element, and linking the IP asset, the metadata element, the log element, the user record of the user, and the user records of any other users indicated in the access control element to the access control element. Updating draft IP assets may involve making changes to the IP elements linked to the IF asset and the metadata of a draft IP asset. Saving a draft IF asset as final and converting a final IF asset back to draft may involve instructing security process 206 to set flags in the access control list of the IF asset that controls when it may be viewed by others. Similarly, assigning subsequent action flags to IP assets may involve instructing security process 206 to set flags in the access control list of the IF asset that indicates whether the IP asset is to be patented, used for a TM, the basis for a copyright, used as a trade secret, publicly disclosed, or designated with any other suitable status.

In preferred embodiments of the invention, asset management process may also incorporate or use features of known docketing systems and trading systems. The docketing systems may facilitate tracking the progress of patent, trademark, and copyright prosecution relating to an IP asset. The trading systems may facilitate the trading of IP assets. An example of a known docketing system is PC Master available from Master Data Center, and an example of a trading system is eBay.com. Any trader with access to the trading system features of the invention may be consider to be a user and thus subject to the same access control functions provided by the security process.

Indexer/cataloger process 214 may be used to index data stored in IP elements, IP assets, metadata elements, log elements, and user records so that that data can be used in an easy and rapid fashion. For example, process 214 may create an index of terms in the data so that a rapid keyword search can be performed on the data. Similarly, process 214 may classify the data so that it is accessible through selection of hierarchical criteria. Process 214 may also include search functions that are performed on demand or periodically. The results of these search functions may then be automatically presented to a user.

Valuation process 216 may be used to assign and track values of IP elements and IP assets. These values may include potential or estimate values, market or actual values, compound or aggregate values, and proportional contributions when multiple creators are involved in creating an IP element or an IP asset. Values may be assigned based upon user input, value estimation models, history information, or any other suitable method for valuing intellectual property. Process 216 may also provide the value information to other known financial calculation processes.

Time stamping/identity process 218 may be used to attach a time and creator information to an IP element, IP asset, metadata element, and/or log element. Time stamping/identity process 218 may obtain a digital signature for the user from security process 206 that is to be used as the creator information.

Crediting process 220 may be used to track the contributions of users to the knowledge base of IP elements and IP assets. For example, a user may receive credit when an IP element is registered. Similarly, a user may receive credit when an IP element is attached to another user's IP elements, linked to an IP asset, flagged to be patented, etc. This credit may then be used to incent the user to submit more IP elements and IP assets. Process 220 may also be used to indicate to users, on demand, what credits have been earned.

Turning to FIG. 3, an example of a user interface 300 that may be presented to a user of a workstation 102 is shown. As illustrated, interface 300 may include a main menu 302 and a welcome page 304. Welcome page 304 may include any suitable greetings and/or information. For example, as shown, page 304 includes a “Welcome!” greeting and a news flash. Main menu 302 may include a my projects option 306, a work calendar option 308, a business office option 310, a links option 312, a references option 314, another links option 316, a help option 318, a my account option 320, and a log out option 322.

Prior to interface 300 being displayed, a user may first be prompted to enter a security token. As stated above, a security token may be a user identification and password, amongst other things. Upon entering the security token, the user may be “logged in.” In order to “log out,” the user may select log out option 322. To alter certain information pertaining to a user's account, the user may select my account option 320. Selecting this option may activate user management process 208. To receive help, a user may select help option 318. Help option 318 may cause a user to be presented with an electronic user's guide, a troubleshooting database, a frequently asked questions list, a live chat help session, an email interface, etc. To access references related to the user's account, a user may select references option 314. Links option 316 may permit easy access to frequently used references by the user. To access business office information, a user may select business office option 310. Links option 312 may permit easy access to frequently used business office information by the user. To access a scheduling calendar, the user may select work calendar option 308. Finally, to access IP element information, a user may select my projects option 306.

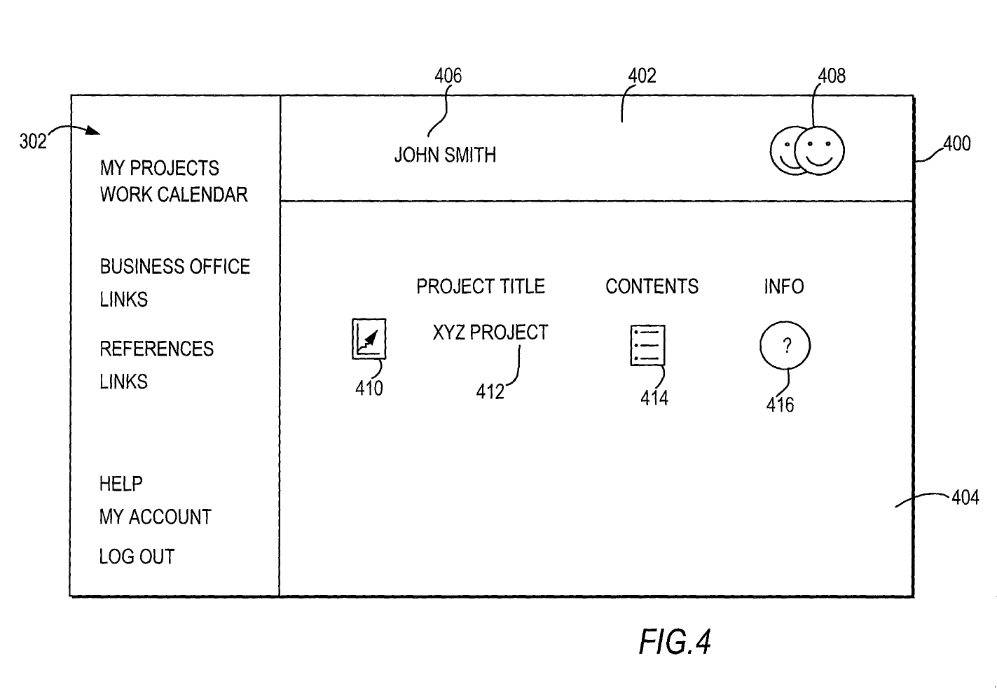

Turning to FIG. 4, an interface 400 that may initially be presented when a user selects my projects option 306 is shown. As illustrated, interface 400 may include a header portion 402 and a body portion 404. Header portion 402 may indicate the user's name in field 406 and present an icon 408 indicating that the user is a member of a team. Body portion 404 may indicate current projects in which the user is involved. As shown, only one project is indicated. This project may be identified by a project icon 410, a project title 412, a project table of contents icon 414, and a project information icon 416.

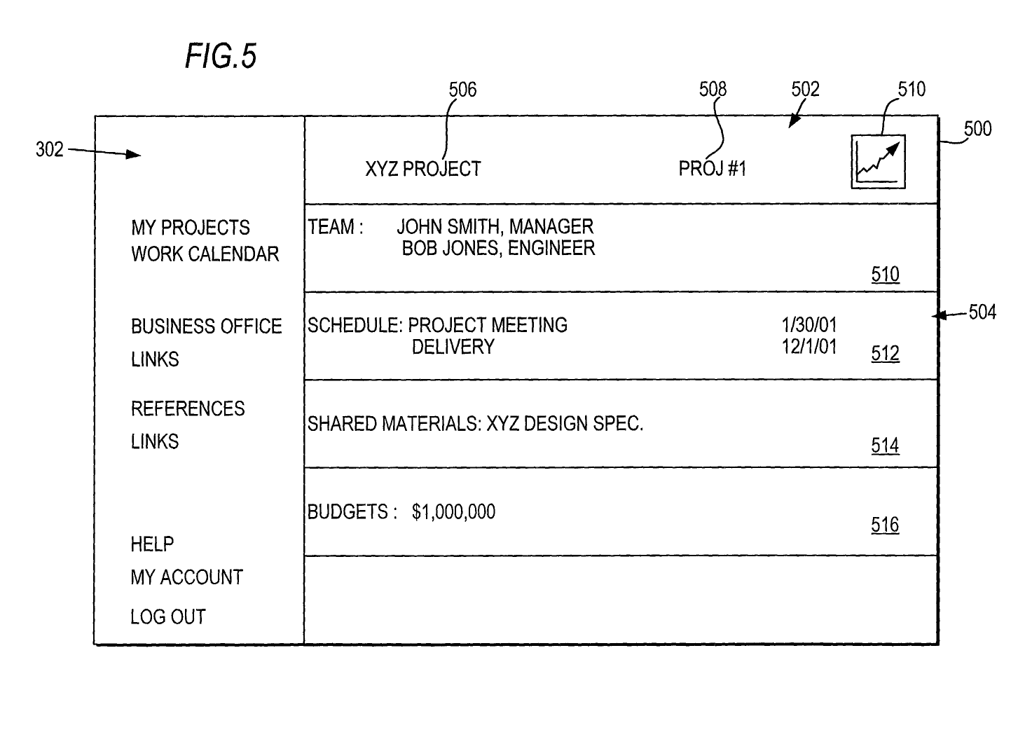

If a user selects project information icon 416, a user interface 500 may be presented as shown in FIG. 5. As can be seen, interface 500 may include a header portion 502 and a body portion 504. Header portion 502 may indicate the title 506, project number 508, and icon 510 of the project corresponding to project information icon 416. Body portion 504 may indicate the team members on the project in area 510, the schedule of the project in area 512, the shared materials on the project in area 514, and the budgets on the project in area 516. Selecting any of the information in areas 510, 512, 514, and 516 may cause the user to be presented with additional information or linked to other sources of related information.

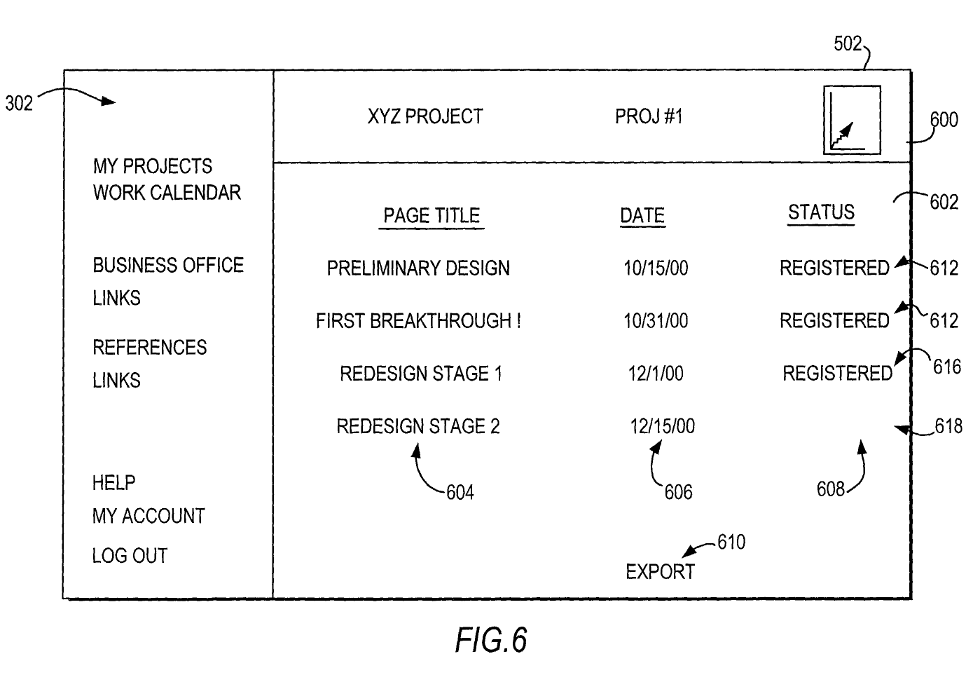

If a user selects project table of contents icon 414, a user interface 600 may be presented as shown in FIG. 6. As can be seen, interface 600 may include a header portion 502 and a body portion 602. Header portion 502 in interface 600 may be substantially identical to portion 502 in interface 500. Body portion 602 may include a plurality a page identifiers 612, 614, 616, and 618. These identifiers identify electronic “lab notebook pages” that may be used to create and view information in IP elements. As shown, these page identifiers may be displayed in three columns 604, 606, and 608. In column 604, each identifier may indicate a title of an IP element that may be stored in the IP elements metadata. In column 606, each identifier may indicate a time stamp date of an IP element. In column 608, each identifier may indicate whether the corresponding IP element was registered. As shown the IP elements corresponding to the pages identified by identifiers 612, 614, and 616 are registered and the IP element corresponding to the page identified by identifier 618 is not registered. Export button 610 may be used to save the table of contents and underlying information to a file for use in another application, such as Microsoft Word.

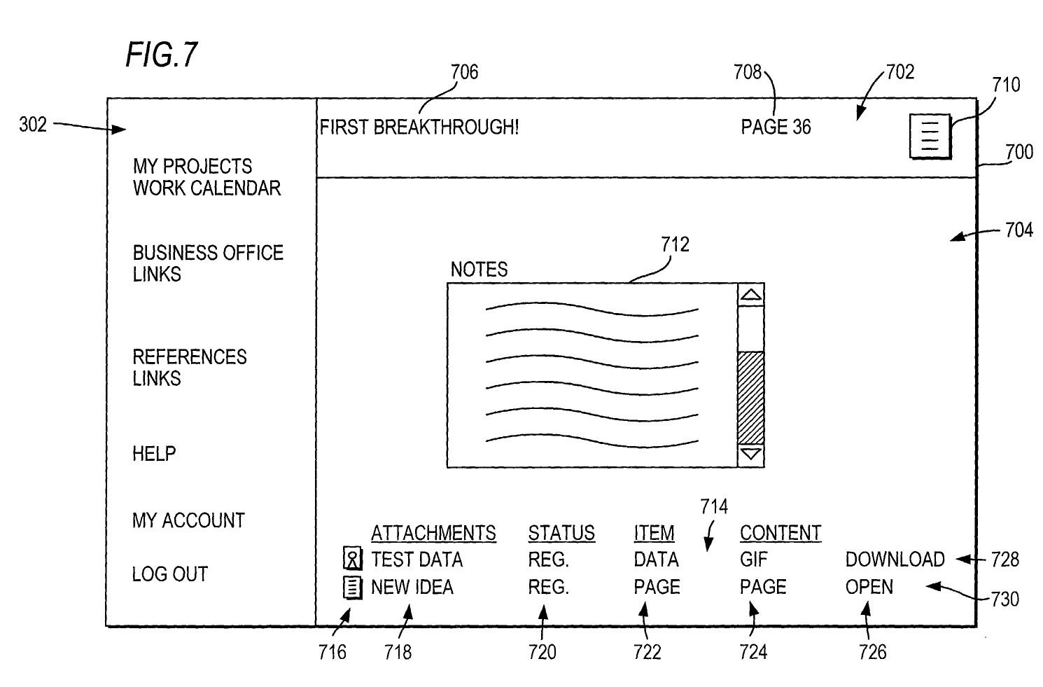

FIG. 7 illustrates an example of an interface 700 that may be displayed when a user selects the page identified by identifier 614 in interface 600. As stated in connection with FIG. 6, a page may be used to create and view information in an IP element. As shown, interface 700 may include a header portion 702 and a body portion 704. Header portion 702 may indicate the title 706, a page number 708, and an icon of the page selected by the user. Body portion 704 may indicate the content of a corresponding IP element in notes are 712 and attachments area 714. As illustrated, attachments area may indicate any attachments that are linked to the IP element. These attachments may be files and/or other IP elements. For example, attachment 728 is a file and attachment 730 is a page for an IP element. Area 714 may indicate for each attachment an attachment icon in column 716, an attachment name in column 718, a registration status in column 720, an attachment type in column 722, an attachment content in column 724, and a download/open button in column 726.

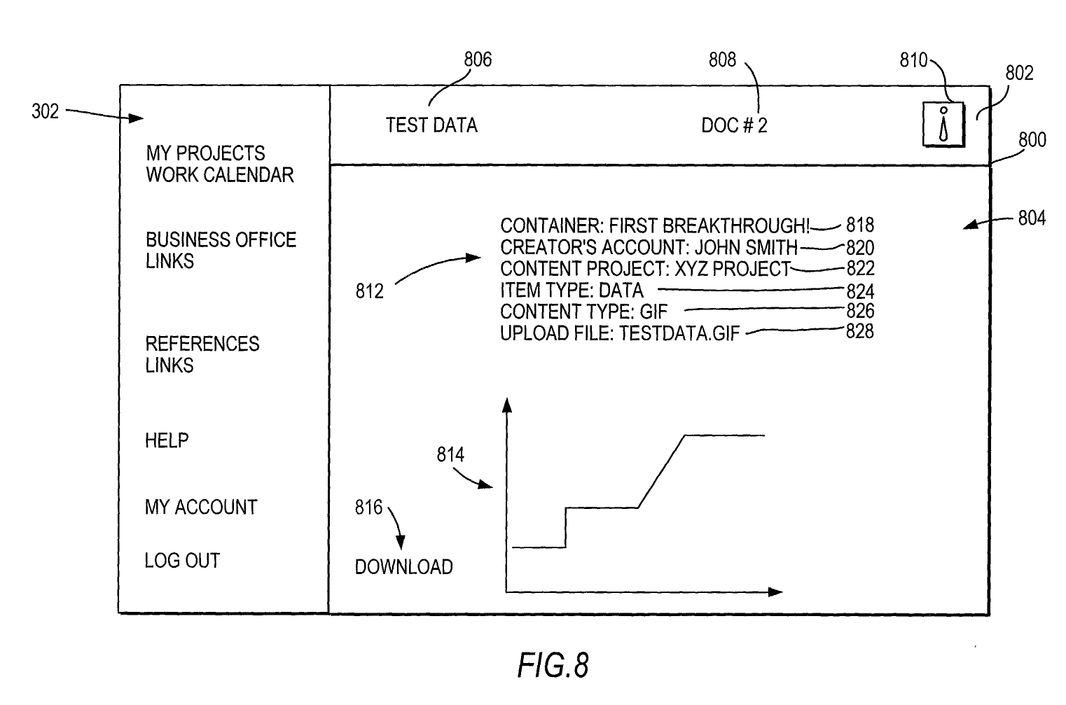

If a user selects attachment 728 from interface 700, the user may be presented with a display 800 as shown in FIG. 8. As illustrated, interface 800 may include a header portion 802 and a body portion 804. Header portion 802 may indicate the name 806, the document number 808, and an icon 810 for the attachment. Body portion 804 may provide information 812 relating to the attachment, an image 814 of the attachment, and a download button 816 for the attachment. Within information 812: the container of the attachment, or page to which the attachment is attached, is indicated by container label 818; the name of the creator of the attachment is indicated by name label 820; the context of the IP element of the attachment is indicate by context label 822; the item type of the attachment is indicated by item type label 824; the content type of the attachment is indicated by content type label 826; and the upload file name of the attachment is indicated by upload file name label 828.

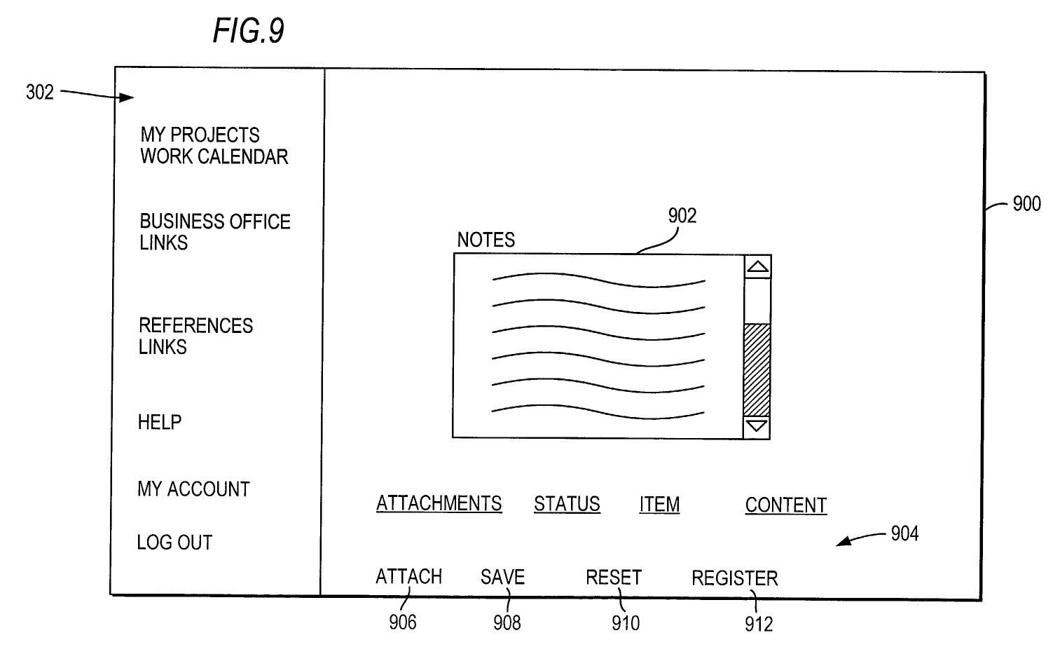

Lastly, turning to FIG. 9, if a user selects project icon 410 or project title 412, an interface 900 may be illustrated as shown. Interface 900 may be used to create a new page or modify a saved by unregistered page corresponding to an IP element. Within interface 900, a notes area 902 and an attachments area 904 may be presented. Notes area 902 permits a user to enter content for the IP element. Attachments area 904 lists attachment information for attachments to the page similar to that discussed in connection with FIG. 7. Attachments may be made by selecting attachments button 906. In response, a user may be prompted whether the attachment is a file or another page, and the identity of the attachment (e.g., a file name if a file, and a page number if a page). Once the user has made changes to the page, but before the user is ready to register the page, the user may save a draft of the page by selecting save button 908. Alternatively, if the user decides not to retain changes made to a draft, the user may select reset button 910. Finally, once a user is satisfied with a draft of a page, the user may select register button 912 to register the page, and thus the corresponding IP element.

Although the invention is described in connection with FIGS. 3-9 by way of an embodiment of the invention using a “lab notebook page” paradigm for creating and manipulating IP elements, it should be apparent that the present invention may be implemented using other paradigms. For example, instead of using a “lab notebook page” paradigm, embodiments of the invention may use a “filing cabinet/folder” paradigm or any other suitable paradigm.

Thus, systems and methods for providing promotions with recorded programs are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for tracking a piece of content comprising:
receiving an entry of the piece of content from a user;
storing the piece of content with a time stamp and an identifier of the user; and
preventing any changes to the piece of content, the time stamp, and the identifier after the piece of content, the time stamp, and the identifier have been stored.

2. The method of claim 1, further comprising presenting a user interface to the user through which the piece of content may be received.

3. The method of claim 2, wherein the user interface is a Web page.

4. The method of claim 2, wherein the user interface is an email client.

5. The method of claim 2, wherein the user interface is presented in a page paradigm.

6. The method of claim 1, further comprising designating the piece of content as having a value to the user.

7. The method of claim 1, further comprising tracking a value associated with the piece of content.

8. The method of claim 7, wherein the value is an estimated value.

9. The method of claim 7, wherein the value is a market value.

10. The method of claim 7, wherein the value is a compound value.

11. The method of claim 7, wherein the value is a proportional value.

12. The method of claim 1, further comprising tracking the owner of the piece of content.

13. The method of claim 1, further comprising providing information relating to the piece of content to a trading system.

14. The method of claim 1, further comprising providing information relating to the piece of content to a docketing system.

15. The method of claim 1, further comprising maintaining metadata relating to the piece of content.

16. The method of claim 1, further comprising maintaining log data relating to the piece of content.

17. The method of claim 1, further comprising maintaining context information relating to the piece of content.

18. The method of claim 17, wherein the context information identifies a collaborative relationship between the user and another user.

19. The method of claim 18, wherein the collaborative relationship is a joint project of the user and the other user.

20. The method of claim 1, further comprising controlling access to the piece of information.

21. The method of claim 1, further comprising maintaining information relating to the user.

22. The method of claim 21, wherein the information relating to the user includes personal information.

23. The method of claim 21, wherein the information relating to the user includes employment information.

24. The method of claim 21, wherein the information relating to the user includes functional role information.

25. The method of claim 24, further comprising controlling access to the piece of content based upon the functional role information.

26. The method of claim 1, further comprising enabling the piece of content to be linked to another piece of content that is already stored.

27. The method of claim 26, wherein the other piece of content was created by another user.

28. The method of claim 1, further comprising enabling the piece of content to be linked to a file.

29. The method of claim 1, further comprising storing the piece of content, the time stamp, and the identifier of the user with a draft status.

30. The method of claim 1, further comprising storing the piece of content, the time stamp, and the identifier of the user with a registered status.

31. The method of claim 1, further comprising linking the content, the time stamp, and the identifier to other information.

32. The method of claim 31, further comprising storing with the content, the time stamp, and the identifier recovery information identifying the other information.

33. The method of claim 1, further comprising storing the content, the time stamp, and the identifier in a permanent form.

34. The method of claim 1, further comprising storing the content, the time stamp, and the identifier in a manner that permits the content to be admissible as evidence.

35. The method of claim 34, wherein the content, the time stamp, and the identifier are stored such that the content, the time stamp, and the identifier cannot be separated.

36. The method of claim 1, further comprising submitting the content, the time stamp, and the identifier to a witness.

37. The method of claim 36, wherein the witness is a third party.

38. The method of claim 36, wherein the witness is a process.

39. The method of claim 1, further comprising generating a digital fingerprint for the content, the time stamp, and the identifier, and storing the digital fingerprint.

40. A system for tracking a piece of content comprising:
a workstation that receives an entry of the piece of content from a user; and
a server that stores the piece of content with a time stamp and an identifier of the user, and prevents any changes to the piece of content, the time stamp, and the identifier after the piece of content, the time stamp, and the identifier have been stored.

41. The system of claim 40, wherein the workstation also presents a user interface to the user through which the piece of content may be received.

42. The system of claim 41, wherein the user interface is a Web page.

43. The system of claim 41, wherein the user interface is an email client.

44. The system of claim 41, wherein the user interface is presented in a page paradigm.

45. The system of claim 40, wherein the server also designates the piece of content as having a value to the user.

46. The system of claim 40, wherein the server also tracks a value associated with the piece of content.

47. The system of claim 46, wherein the value is an estimated value.

48. The system of claim 46, wherein the value is a market value.

49. The system of claim 46, wherein the value is a compound value.

50. The system of claim 46, wherein the value is a proportional value.

51. The system of claim 40, wherein the server also tracks the owner of the piece of content.

52. The system of claim 40, wherein the server also provides information relating to the piece of content to a trading system.

53. The system of claim 40, wherein the server also provides information relating to the piece of content to a docketing system.

54. The system of claim 40, wherein the server also maintains metadata relating to the piece of content.

55. The system of claim 40, wherein the server also maintains log data relating to the piece of content.

56. The system of claim 40, wherein the server also maintains context information relating to the piece of content.

57. The system of claim 56, wherein the context information identifies a collaborative relationship between the user and another user.

58. The system of claim 57, wherein the collaborative relationship is a joint project of the user and the other user.

59. The system of claim 40, wherein the server controls access to the piece of information.

60. The system of claim 40, wherein the server maintains information relating to the user.

61. The system of claim 60, wherein the information relating to the user includes personal information.

62. The system of claim 60, wherein the information relating to the user includes employment information.

63. The system of claim 60, wherein the information relating to the user includes functional role information.

64. The system of claim 63, wherein the server also controls access to the piece of content based upon the functional role information.

65. The system of claim 40, wherein the server also enables the piece of content to be linked to another piece of content that is already stored.

66. The system of claim 65, wherein the other piece of content was created by another user.

67. The system of claim 40, wherein the server also enables the piece of content to be linked to a file.

68. The system of claim 40, wherein the server also stores the piece of content, the time stamp, and the identifier of the user with a draft status.

69. The system of claim 40, wherein the server also stores the piece of content, the time stamp, and the identifier of the user with a registered status.

70. The system of claim 40, wherein the server links the content, the time stamp, and the identifier to other information.

71. The system of claim 70, wherein the server stores with the content, the time stamp, and the identifier recovery information identifying the other information.

72. The system of claim 40, wherein the server stores the content, the time stamp, and the identifier in a permanent form.

73. The system of claim 40, wherein the server stores the content, the time stamp, and the identifier in a manner that permits the content to be admissible as evidence.

74. The system of claim 73, wherein the content, the time stamp, and the identifier are stored such that the content, the time stamp, and the identifier cannot be separated.

75. The system of claim 40, wherein the server submits the content, the time stamp, and the identifier to a witness.

76. The system of claim 75, wherein the witness is a third party.

77. The system of claim 75, wherein the witness is a process.

78. The system of claim 40, wherein the server generates a digital fingerprint for the content, the time stamp, and the identifier, and stores the digital fingerprint.
